(19) United States
(12) Patent Application Publication
(10) Pub. No.: US 2003/0214140 A1
(43) Pub. Date: Nov. 20, 2003

(54) Combination bottle holder and pitcher type container

(76) Inventor: L. Grant Lynd, Canal Winchester, OH (US)

Correspondence Address: Francis T. Kremblas, Jr., 7632 Slate Ridge Blvd, Reynoldsburg, OH, 43068, US

(21) Appl. No.: 10/147,258

(22) Filed: May 15, 2002

(51) Int. Cl. A47J 45/00; B65D 23/10

(52) U.S. Cl. 294/27.1; 294/31.2; 215/396; 220/758; 220/737

(57) ABSTRACT

A combination soft drink bottle holder and pitcher type container is disclosed which is specifically adapted to receive a conventional two liter soft drink bottle in a releasable friction fit relationship. The holder and container device includes an integral; handle which permits one to handle and pour the contents of the soft drink bottle in a facile, yet secure manner. When used independently as a pitcher container, without the soft drink bottle, free standing liquids in the pitcher may be stored and poured from the container in a similar manner to conventional pitchers. In a preferred embodiment, a removably lid is provided which fits within top opening of the container and allows pouring of free flowing liquids from the pitcher container without removing the lid which is rotatably mounted between open and closed positions.

### (b) CROSS-REFERENCE TO RELATED APPLICATIONS

(Not applicable)

### (c) STATEMENT REGARDING FEDERALLY SPONSORED, RESEARCH OR DEVELOPMENT

(Not Applicable)

### (d) REFERENCE TO A “MICROFICHE APPENDIX”

(Not Applicable)

### (e) BACKGROUND OF THE INVENTION

1. Field of Invention

The present invention relates generally to devices adapted to facilitate the handling and manipulation of conventional large plastic soft drink bottles and particularly to a dual function device for facilitating such handling of the soft drink bottle and also may be used as a self-standing pitcher-type container for liquids.

2. Background of Related Art

Large plastic soft drink bottles having a two liter capacity, for example, have been sold in great numbers and are popular because of the lower price per unit volume of the liquid contents. Conventionally such bottles have a substantial diameter and the walls comprise relatively thin plastic for economy of packaging.

The diameter of the major portion of the bottle renders handling the bottle awkward and often difficult, particularly for younger children and elderly adults. Most persons must use both hands in order to manipulate the bottle when pouring the contents to avoid inadvertent dropping of the bottle or accidental spillage.

These handling drawbacks are well-known and over the past couple of decades there has been several prior efforts to overcome these drawbacks and facilitate the use of such large size soft drink bottles.

Some representative examples of prior attempts to solve the noted problem are found in U.S. Pat. Nos. 5,816,631; 5,183,169; 5,013,074; 5,413,231; 4,552,396; 4,666,197 and other U.S. patents cited therein.

Generally all of these patents relate to a removably mounted handle structure wherein the devices provide for releasably connecting a handle in an operative relationship to the bottle.

Some of these devices require more manipulation than others to mount or remove the handle structure from the bottle and some appear to be more secure than others relative to the mounted relationship with the bottle. However, all are limited to a reusable handle accessory for use with such bottles.

### (f) BRIEF SUMMARY OF THE DISCLOSURE

In one aspect of the present invention, a bottle holder and independent or self-standing liquid container combination is provided which has dual functional advantageous to the user.

As another aspect of the invention, when used as a holder for the popular two liter size soft drink bottles, the holder and handle configuration permit very simple manipulation to releasably join the bottle and holder, yet provides a secure relationship to facilitate handling and pouring liquid from soft drink bottle.

As another aspect of the present invention, the combination holder/container configuration may be used independently as a pitcher to store and conveniently pour free-flowing liquids from the pitcher type container in the same manner as a conventional pitcher.

As another aspect of the present invention, it is provided with structure which securely holds the soft drink bottle within the holder/container and still permits the bottle to be removed without difficulty or awkward manipulation being required.

As a further aspect of the present invention, the holder/container structure includes means which facilitates nesting of individual units thereof for more compact shipment for storage and volume distribution purposes.

As still another aspect of the present invention, a preferred embodiment includes a cap or lid for advantageous use of the present invention as a pitcher type container. The lid also may be conveniently releasably mounted to the bottom of the container such that the lid may remain attached to the holder/container even when it is used in the bottle holder configuration. This feature tends to reduce inadvertent misplacement of the lid for later use.

### (g) BRIEF DESCRIPTION OF THE DRAWINGS

FIG. 1 is a perspective view of one preferred embodiment of the present invention illustrating the dual purpose bottle holder/container and the removable lid which is shown in exploded relationship to the top of the holder/container;

FIG. 2 is another perspective view of the embodiment shown in FIG. 1;

FIG. 3 is a perspective view similar to the view shown in FIG. 1 of the present invention illustrating the storage position of the removable lid mounted on the bottom of the holder/container;

FIG. 4 is a top plan view of a holder/container device shown in FIG. 1;

FIG. 5 is a side elevational view of device shown in FIG. 1;

FIG. 6 is a side elevational view in section of the device shown in FIG. 5, the section being taken along line 6-6 in FIG. 5;

FIG. 7 is a bottom plan view of the device shown in FIG. 6;

FIG. 8 is a side elevational view in section such as shown in FIG. 6 illustrating the device when used as a bottle holder, the bottle being shown in ghost lines;

FIG. 9 is a top plan view similar to the view shown in FIG. 4 illustrating the removable lid feature of one preferred embodiment with the lid seated within the top opening of the holder/container; and

FIG. 10 is a side sectional view similar to the sectional view shown in FIG. 6 illustrating a nested configuration of two of the holder/containers constructed in accordance with the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### (h) DETAILED DESCRIPTION OF THE INVENTION

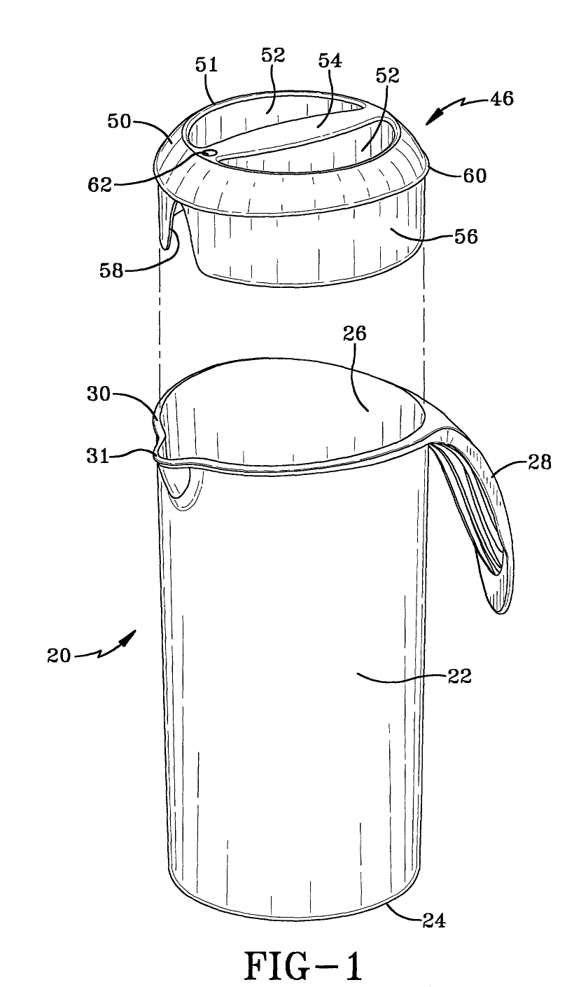

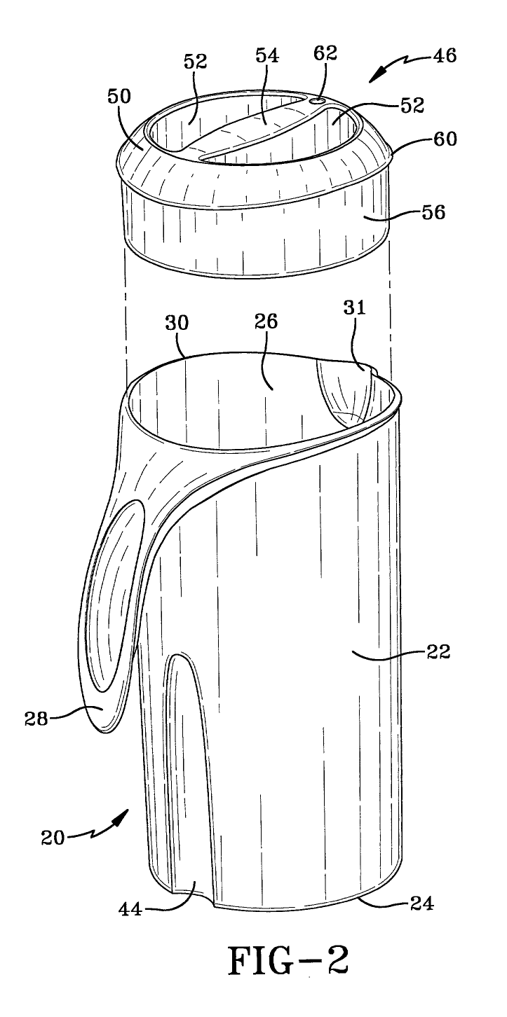

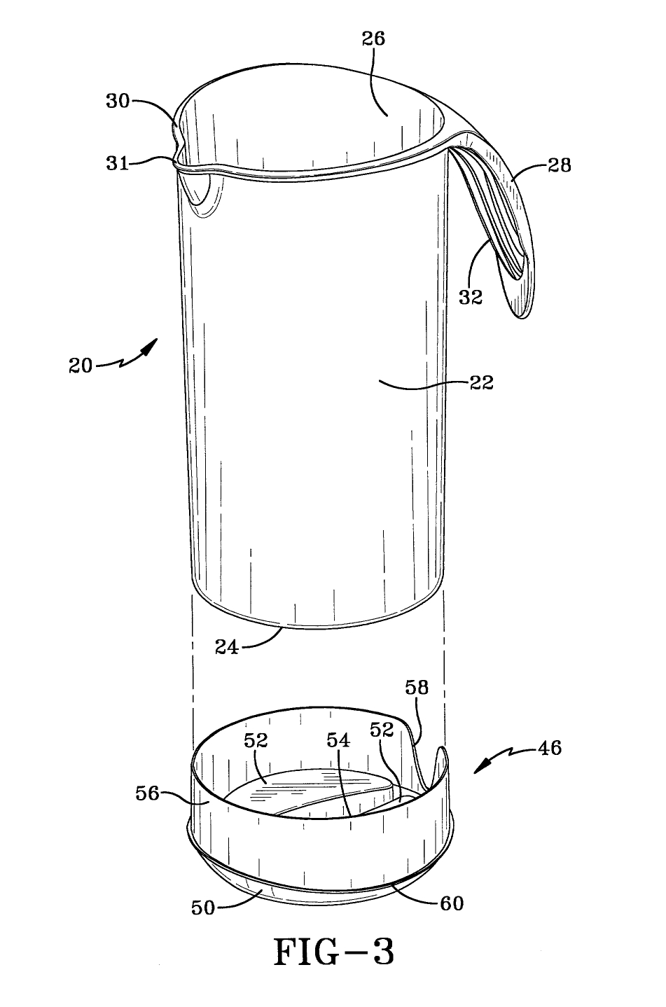

A preferred embodiment of a soft drink bottle holder and pitcher type container combination constructed in accordance with the present invention is shown in FIGS. 1-3 and includes a main body indicated generally at 20 provided with a generally cylindrical side wall 22 and a bottom wall 24. The side and bottom walls 22, 24 form an enclosure having a top opening 26. A handle 28 is preferably integrally molded to the upper end of the side walls 22 adjacent to a rim 30 surrounding top opening 26.

The configuration and size of main body 20 is selected to conform to the cylindrical dimensions of the well-known, conventional two liter soft drink bottle and has a height dimension equal to a sufficient portion of the height of the soft drink bottle such that the bottle may be securely removably mounted within the side walls 22. The holder body 20 with a bottle mounted therein may be handled and manipulated solely using the handle 28. In this connection, the more preferred depth or height dimension of side wall 22 is between about 50 to about 80 percent of the total height of the two liter soft drink bottle.

In accordance with the above more preferred height dimension, the upper portion of this range is most preferred to provide greater facility in manipulating the soft drink bottle using the handle 28 and to provide a greater volume capacity when body 20 is used independently as a pitcher-type container.

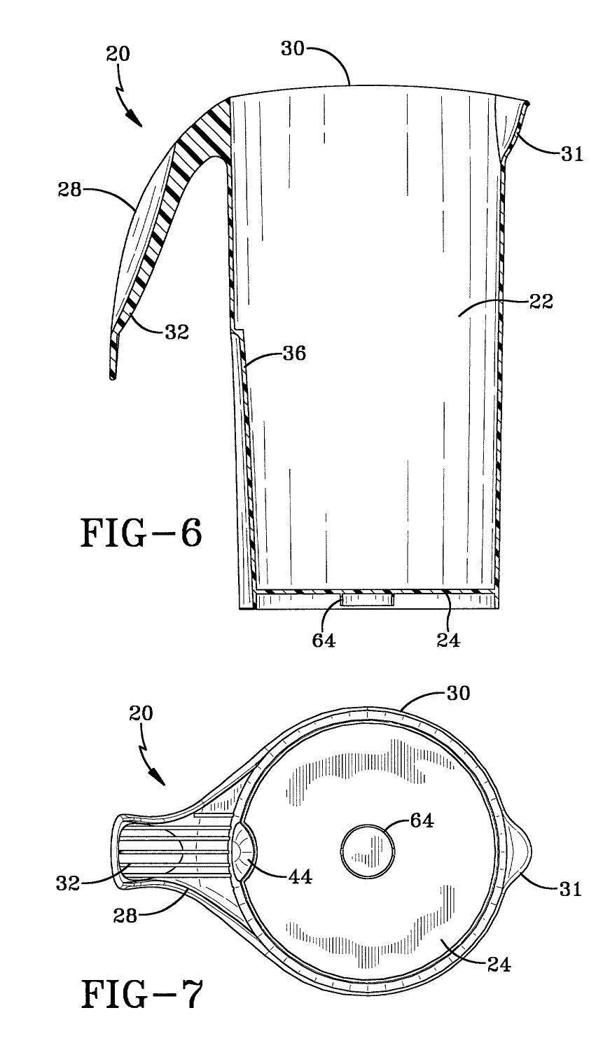

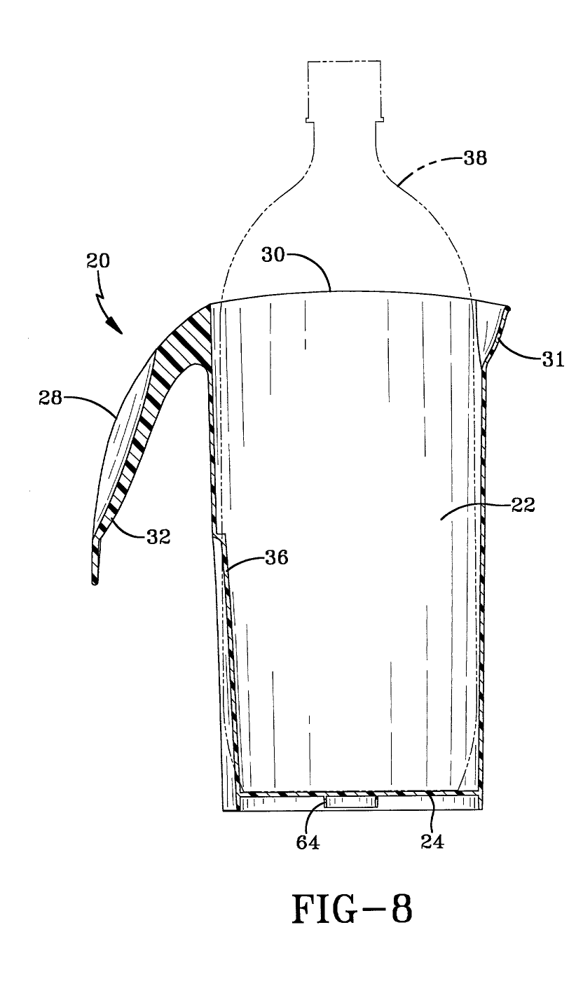

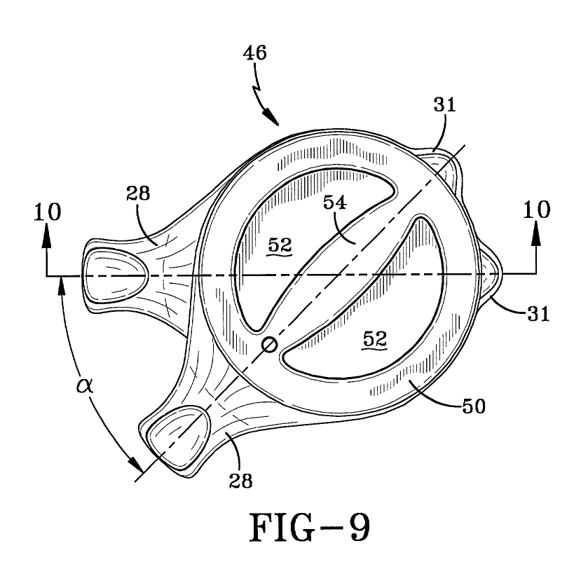

With specific reference to FIGS. 6-8, handle portion 28 extends downwardly and preferably has a slightly curved configuration, as seen in FIG. 6. Handle 28 may be provided with a plurality of ridges, such as at 32, on the lower surface thereof to provide means to more securely grip the handle 28.

Rim 30 preferably is provided with an outwardly extending lip portion 31 which serves as a pour spout when body 20 is used solely as a pitcher-type container to aid in pouring liquid contents out of the body 20.

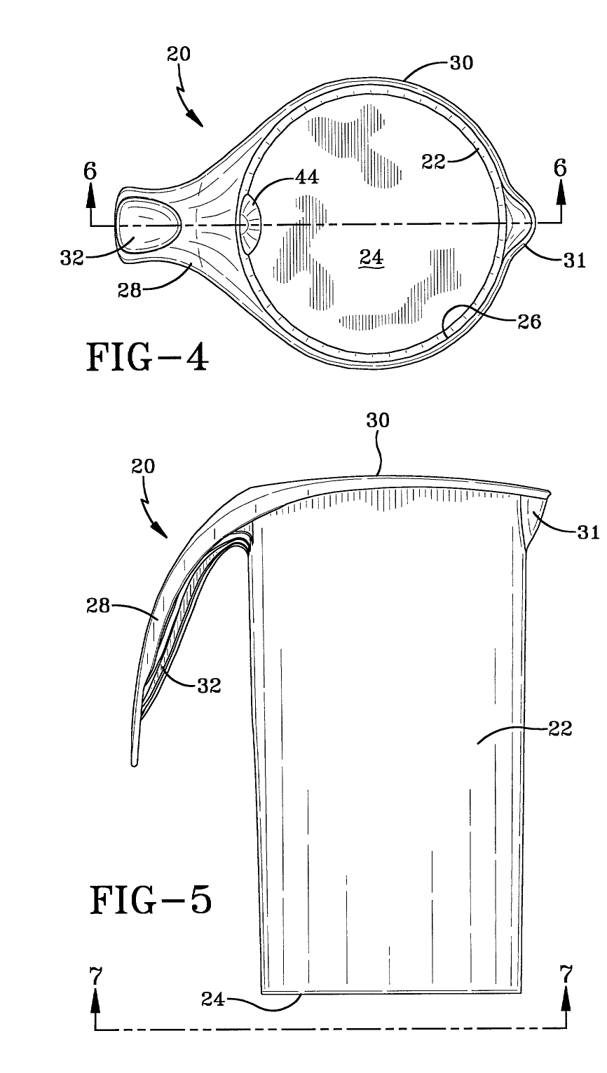

As best seen in FIGS. 4-6, side walls 22 are preferably provided with a very slight taper from top opening 26 toward the bottom wall 24 which facilitates the molding process preferred for economical manufacture and permits easy nesting of the plural bodies 20 within one another for storage and shipping purposes.

A longitudinally extending bead or ridge 36 is provided on an inner surface of side walls 22 and provides a dual function. Bead 36 narrows the inner diameter defined by side walls 22 to ensure a friction fit with a conventional two liter bottle 38, such as shown in FIG. 8. The degree of frictional resistance is selected to provide a releasable, yet sufficiently secure hold on the bottle 38. Further, the general ridge-like configuration of bead 36 across its width provides the highest point generally centrally along its longitudinal length to assure a passage for air is formed between the sides of bottle 38 and side walls 22. This prevents a suction phenomena from occurring upon inserting the bottle 38 into the body 20 in a normal operative holder position. Formation of a negative pressure upon inserting bottle 38 would likely render removal of bottle 38 undesirably difficult.

Preferably, bead 36 tapers in width from a smaller upper end 40 toward the larger lower end 42 which terminates at bottom wall 24 and includes a small and gradual taper inwardly from upper end 40 toward lower end 42 which facilitates inserting and removal of bottle 38 relative to the inner space defined by sidewalls 22. Further, this construction is related to the nested configuration of one body 20 within another as the upper end 40 is formed with a flat surface generally perpendicular to side walls 22 to act as a stop engaging the lower edge of side walls 22 of a similar body 20 being nested within another body 20.

It is more preferred to construct body 20 from a strong and moldable plastic material having a thickness which resists easy deformation in order to better support the weight of the contents of soft drink bottle 38 and to support the weight of a free flowing liquid, such as a fruit juice, lemonade or other such liquid when used independently as a pitcher type container.

It is desirable to form a groove or depression 44 on the outer surface of side walls 22 which closely conforms to the shape of bead 36 to reduce the thickness of sidewall 22 at the location of bead 36. This tends to facilitate the molding process by reducing the cooling time necessary before the body 20 may properly be removed from the mold.

In the most preferred form of the present invention, a molded, removable lid 46 is provided which includes a top wall 50 having a pair of depressions 52 forming an elongate knob 54 which facilitates manual handling and manipulation of lid 46.

Lid 46 includes a downwardly depending flange 56 defining a cylindrical shape selected to be received into top opening 26 in a light friction-fit in a manually rotatable relationship with the inner surface of side walls 24 adjacent to top opening 26. A lip 60 overhangs flange 56 so as to rest upon rim 31 and functions as a stop for properly seating lid 46 within top opening 26.

The degree of the friction-fit relationship selected allows rotation of flange 56 within top opening 26 such that an opening formed by a cut-out portion 58 of flange 56 may be rotationally aligned with pour spout 31. Liquid contents in body 20 may then be poured out without removing lid 46. Rotation of lid 46 and cut-out portion 58 to a closed position relative to spout 31 tends to reduce inadvertent spilling of the contents when otherwise handling body 20 when used as a pitcher.

Preferably, knob 54 is longitudinally aligned with the opening formed by cut-out portion 58 and lip 60 is curved relative to the horizontal, i.e., at right angles to the longitudinal axis of side walls 22, such that flange 56 is fulled seated in a level relationship on rim 30 of body 20 preferably in two opposing positions 180 degrees from one another relative to cut-out portion 58 and pour spout 31 to define an open and closed position. A small circular depression 62 may be provided adjacent to the end of elongate knob 54 aligned with cut-out portion 58 to serve as an indicator to visually indicate the end of knob 54 aligned with cut-out portion 58.

The inside diameter formed by the circular flange 56 is also selected to closely conform to the outside diameter defined by the lower end portion of side walls 22 adjacent bottom wall 24 to provide a relatively light friction-fit between the inside surface of flange 56 and the outer surface of side walls 22.

Preferably, side walls 22 are molded to extend below bottom wall 24 to form a downwardly depending flange 62 which serves to provide a more level surface for body 20 to rest upon a flat surface such as a table, kitchen counter or shelf for example.

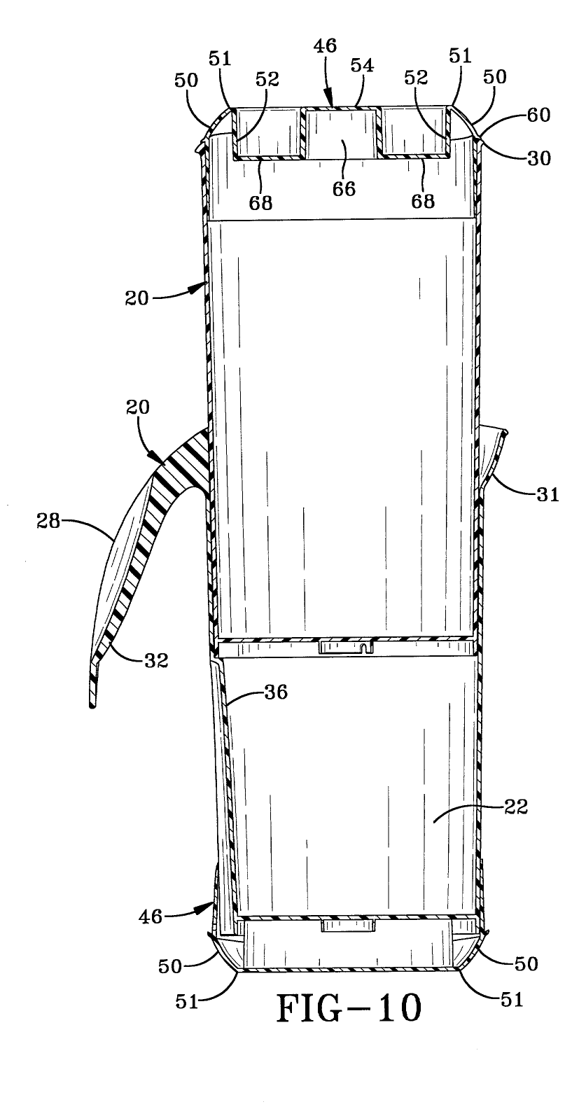

This structure is advantageous in the molding process to reduce holding time but further serves to allow a generally ring shaped downwardly descending flange 64 to be formed on bottom wall 24. The dimensions of lip 64 are selected so as to be centrally received in the hollow or groove 66 formed between downwardly extending pads 68 in lid 46 in a friction fit relationship to securely snap lid 46 over ring shaped flange 64 with flange 56 sliding over the lower portion of side walls 22, as shown in FIG. 10 and described above. This permits lid 46 to be securely, yet removably mounted to body 20 when not used to cover top opening 26. This feature allows lied 46 to be conveniently available when desired and less likely to be misplaced or lost when not in use.

When lid 46 is mounted over the bottom wall 24 as described, it still provides a level surface for resting body 20 upon a table or the like in a stable manner such as described earlier with regard to lip 62. A generally horizontal plane, defined by the upper edge 51 of the downwardly directed areas 50 of lid 46 and the planar upper surface of knob 54, form a stable base to support body 20 in an upright resting position with lid 46 mounted over bottom surface 24 as seen in FIG. 10.

Although the holder/container may be independently sold, the relatively large area represented by the outer surface of side walls 22 provides ample space for advertising indicia. Therefore it also may be advantageously employed as a promotional gift offered with the sale of a particular soft drink or in some other promotional advertising venture. Printed indicia or conventional adhesive labels may be applied to the body 20 as is well-known in the art to provide the advertising content.

In either case, the user may choose to use the body 20 for a holder of large soft drink bottles as described as well as a pitcher for free flowing liquids as desired. Therefore the holder/container combination of the present invention is a new and useful device which provides new advantages to the end user.

When body 20 is used in the holder configuration, a conventional two liter bottle 38 may be inserted through top opening 26 and between side walls 22 using a relatively mild degree of force to push bottle 38 downwardly until substantially fully seated within body 20, such as shown in FIG. 8. The degree of frictional gripping or holding of bottle 38 is controlled primarily by the selection of the depth bead 36 extends inwardly away from the interior surfaces of the adjacent side walls 22. The degree of the holding force is selected to be sufficient to securely maintain bottle 38 within the body 22 during the necessary tilting of body 22 to pour out the contents of bottle 38, but not so great as to make intentional manual removal of bottle 38 from within body 22 undesirably difficult.

Manual removal of bottle 38 may be accomplished by holding the top portion of bottle 38 in one hand and body 22 in the other, then pulling in opposite directions. Generally, a slight twisting motion relative to the bottle 38 and body 20, in combination with the pulling motion makes it easier to overcome the frictional forces holding bottle 38 within body 22.

As noted earlier herein, the configuration of bead 36 provides air passages between the outer surfaces of the side walls of the bottle 38 and the inner surfaces of side walls 22 to avoid an air lock to occur wherein a suction force is developed which would make removal of bottle 38 from container body 20 very difficult and wholly undesirable.

When the user elects to use body 20 as a conventional pitcher, free flowing liquids may be poured into body 20 and poured out in conventional fashion as desired.

Lid 46 is optional, but is beneficial when body 20 is used as a pitcher containing free flowing liquids. The rotational movement of lid 46 between open and closed positions provides an added feature convenient to reduce inadvertent spillage of the liquid contents of body 20 while allowing contents to be poured out without removal of the lid 46.

While certain preferred embodiments of the present invention have been disclosed in detail, it is to be understood that various modifications may be adopted without departing from the spirit of the invention or scope of the following claims.

1. A container configured for use as a bottle holder for large plastic soft drink bottles comprising in combination:
a) generally cylindrical side walls having a height dimension equal to at least about fifty to eighty percent of the total height dimension of a conventional two liter soft drink bottle, a bottom wall integrally connected to one end of said side walls; a top opening at the opposing end of said side walls, and an integrally formed handle member extending outwardly from said side walls;
b) an interior surface of said sidewalls defining a chamber having a diameter greater than the largest diameter of a conventional cylindrical two liter plastic soft drink bottle;
c) an elongate inwardly directed bead extending along the inner surface of said side walls and configured to engage a portion of an outer wall of a plastic soft drink bottle disposed within said chamber in a force transmitting relationship to create a releasable friction-fit between said bottle and a portion of the interior surface of said side walls enabling a user to conventionally pour the contents out of said soft drink bottle by gripping the handle of said container and tilting the container with said bottle securely held in said container.

2. The container defined in claim 1 wherein said top opening includes an outwardly extending recess forming a pour spout tending to direct free flowing liquid contents in said container through said pour spout upon tilting said container in a direction toward said pour spout.

3. The container defined in claim 1 further including a removably mounted lid having a downwardly depending generally cylindrical flange configured to frictionally engage an inner surface of said side walls surrounding said top opening and to frictionally engage the outer surface of said side walls surrounding said bottom wall.

4. The container defined in claim 3 wherein the frictional engagement of said lid within the inner surface of said side walls is of a degree to permit manual rotation of said lid relative to said top opening and further said lid including an opening in said in the downwardly depending flange which may be rotationally aligned with said pour spout to allow free flowing liquid contents in said container to be poured out through said spout without removing said lid from said top opening of said container.
